(19) United States
(12) Patent Application Publication
(10) Pub. No.: US 2016/0191860 A1
(43) Pub. Date: Jun. 30, 2016

(54) APPARATUS AND METHOD FOR DISPLAYING SURVEILLANCE AREA OF CAMERA

(71) Applicant: Electronics and Telecommunications Research Institute, Daejeon (KR)

(72) Inventor: Sung-Uk JUNG, Daejeon (KR)

(21) Appl. No.: 14/969,685

(22) Filed: Dec. 15, 2015

(30) Foreign Application Priority Data
Dec. 24, 2014 (KR) 10-2014-0188780

(51) Int. Cl. H04N 7/18; G06K 9/62; H04N 5/232

(52) U.S. Cl. CPC H04N 7/183; H04N 5/23238; H04N 5/23293; G06K 9/6201

(57) ABSTRACT

The apparatus for displaying a surveillance area includes: a data receiving unit receiving position information of a camera and data on a photographed image of the camera; a panorama image generating unit generating a panorama image for surrounding of a position of the camera using a surrounding image of the position of the camera; a matching information calculating unit calculating first matching information between the panorama image and the photographed image of the camera and second matching information between a map associated with the panorama image and a geographic information system map; a surveillance area estimating unit estimating the surveillance area of the camera on the basis of the first matching information and the second matching information; and a surveillance area displaying unit displaying the estimated surveillance area on the geographic information system map.

### CROSS REFERENCE TO RELATED APPLICATION

This application claims the benefit of Korean Patent Application No. 10-2014-0188780, filed on Dec. 24, 2014, entitled “Apparatus and Method for Displaying Surveillance Area of Camera”, which is hereby incorporated by reference in its entirety into this application.

### BACKGROUND OF THE INVENTION

1. Technical Field

The present invention relates to an apparatus and a method for automatically interworking cameras with a geographic information system map, and more particularly, to an apparatus and a method for estimating surveillance areas of cameras using a street view service and displaying the estimated surveillance areas on a geographic information system map.

2. Description of the Related Art

Recently, a closed circuit television (CCTV), which is one of crime prevention and social safety systems, has played an important role. Particularly, it is one of important issues in image surveillance to track an object such as a person, an automobile, or the like, through interworking between a plurality of cameras.

An intelligent CCTV field requiring a real time image analysis, which is a field in which it is required to secure and supply a foundation technology in order to cope with a threat to safety of individuals and a society, such as a terror, a crime, a disaster, and the like, has been required to be actively supported in order to realize a safe future society. Recently, existing patrol and surveillance manpower has been replaced by an IP based CCTV for the purpose of state-of-the-art public peace, security maintenance, and the like, and a new paradigm of social safety system that is not a paradigm for prevention of a terror using an existing infrastructure has been demanded after the Boston bombings.

### SUMMARY OF THE INVENTION

An object of the present invention is to provide an apparatus and a method for estimating surveillance areas of cameras and displaying the estimated surveillance areas on a geographic information system map in order to track an object over an entire area.

Another object of the present invention is to provide an apparatus and a method for estimating surveillance areas of cameras using a commercialized street view service and displaying the estimated surveillance areas on a geographic information system map.

According to an exemplary embodiment of the present invention, an apparatus for displaying a surveillance area includes: a data receiving unit receiving position information of a camera and data on a photographed image of the camera; a panorama image generating unit generating a panorama image for surrounding of a position of the camera using a surrounding image of the position of the camera; a matching information calculating unit calculating first matching information between the panorama image and the photographed image of the camera and second matching information between a map associated with the panorama image and a geographic information system map; a surveillance area estimating unit estimating the surveillance area of the camera on the basis of the first matching information and the second matching information; and a surveillance area displaying unit displaying the estimated surveillance area on the geographic information system map.

The panorama image generating unit may obtain the surrounding image of the position of the camera using a street view service.

The first matching information and the second matching information may include at least one of position, rotation, and size transformation information.

The data receiving unit may further receive a camera internal variable value including at least one of information on an angle of view of the camera and information on a resolution of the camera.

The surveillance area displaying unit may display the estimated surveillance area of the camera on the geographic information system map on the basis of at least one of the information on the angle of view and the information on the resolution.

According to another exemplary embodiment of the present invention, a method for displaying a surveillance area includes: receiving position information of a camera and data on a photographed image of the camera from the camera; generating a panorama image for surrounding of a position of the camera using data on a surrounding image of the position of the camera; calculating first matching information between the panorama image and the photographed image; calculating second matching information between a map associated with the panorama image and a geographic information system map; estimating the surveillance area of the camera on the basis of the matching information; and displaying the estimated surveillance area on the geographic information system map.

### BRIEF DESCRIPTION OF THE DRAWINGS

FIG. 1 is a block diagram illustrating an apparatus for displaying a surveillance area according to an exemplary embodiment of the present invention.

FIG. 2 is a flow chart illustrating a method for displaying a surveillance area according to the exemplary embodiment of the present invention.

FIG. 3 is a flow chart illustrating processes of generating a panorama image according to an exemplary embodiment of the present invention.

FIG. 4 is a flow chart illustrating processes of calculating matching information according to an exemplary embodiment of the present invention.

FIG. 5 is a view for describing matching between a panorama image and a photographed image of a camera according to an exemplary embodiment of the present invention.

FIG. 6 is a view illustrating an example of displaying an estimated surveillance area of a camera on a geographic information system map according to an exemplary embodiment of the present invention.

FIG. 7 is a view for describing a method for estimating a surveillance area of a camera on the basis of first matching information and second matching information according to an exemplary embodiment of the present invention.

DESCRIPTION OF THE EXEMPLARY EMBODIMENTS

The present invention may be variously modified and have several exemplary embodiments. Therefore, specific exemplary embodiments of the present invention will be illustrated in the accompanying drawings and be described in detail in the present specification. However, it is to be understood that the present invention is not limited to a specific exemplary embodiment, but includes all modifications, equivalents, and substitutions without departing from the scope and spirit of the present invention. When it is determined that the detailed description of the known art related to the present invention may unnecessarily obscure the gist of the present invention, the detailed description thereof will be omitted. In addition, singular forms used in the present specification and claims are to be interpreted as generally meaning “one or more” unless described otherwise.

Hereinafter, an exemplary embodiment of the present invention will be described in detail with reference to the accompanying drawings. In describing an exemplary embodiment of the present invention with reference to the accompanying drawings, components that are the same as or correspond to each other will be denoted by the same reference numerals, and an overlapped description thereof will be omitted.

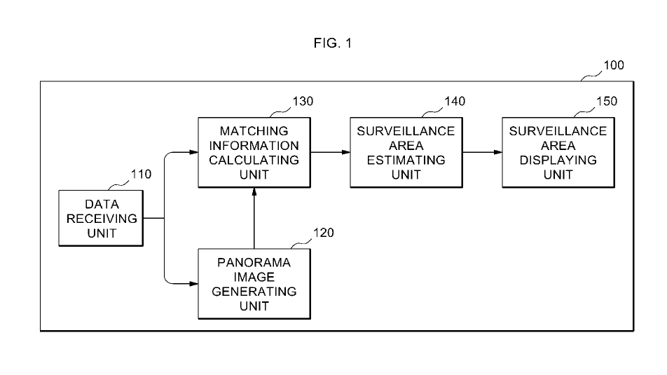

FIG. 1 is a block diagram illustrating an apparatus for displaying a surveillance area according to an exemplary embodiment of the present invention.

Referring to FIG. 1, the apparatus 100 for displaying a surveillance area may include a data receiving unit 110, a panorama image generating unit 120, a matching information calculating unit 130, a surveillance area estimating unit 140, and a surveillance area displaying unit 150.

The data receiving unit 110 may receive a photographed image of a camera, position information of the camera, and/or a camera internal variable value from the camera through wired and wireless communication networks. In an exemplary embodiment, a camera internal variable may include at least one of an angle of view, the number of pixels, a focal length, a shutter speed, a brightness value, and a resolution.

The panorama image generating unit 120 generates a panorama image for the surrounding of a position of the camera using a surrounding image of the camera. In an exemplary embodiment, the surrounding image of the position of the camera may be obtained through a commercialized street view service (for example, Street View of Google, Street View of Naver, Road View of Daum, or the like). The panorama image generating unit 120 may obtain the surrounding image of the position of the camera received by the data receiving unit 110 through the street view service, and match adjacent images of the obtained surrounding image of the camera to each other to generate a panorama image of 360 degrees.

The matching information calculating unit 130 calculates first matching information between the panorama image and the photographed image of the camera, and second matching information between a map associated with the panorama image and a geographic information system map. This is to make the image of the camera and the geographic information system map the same environment so that the surveillance area estimating unit 140 may estimate a position of the photographed image of the camera on the geographic information system map using a correlation between the street view service and the map.

The matching information calculating unit 130 matches the photographed image of the camera received by the data receiving unit 110 to the panorama image generated by the panorama image generating unit 120 to calculate matching information (first matching information) between the panorama image and the photographed image of the camera.

In addition, the matching information calculating unit 130 matches the geographic information system map to the map to calculate matching information (second matching information) between the map associated with the panorama image and the geographic information system map. Here, the matching information calculating unit 130 may adjust the geographic information system map depending on a scale of the map and positions of north, south, east, and west of the map in order to match between the map and the geographic information system map to each other.

Here, the map means a map on which a position of the photographed image of the camera in the panorama image may be displayed without performing a separate matching process. In addition, the geographic information system map means a map on which a user is to finally display a position of the photographed image of the camera.

In an exemplary embodiment, the first matching information and the second matching information calculated by the matching information calculating unit 130 may include at least one of rotation, size, and position information of the image.

In an exemplary embodiment, the map may be a map provided together with the street view service, such as Daum Road View of Daum Map, Naver Street View of Naver Map, or the like.

In an exemplary embodiment, the geographic information system map may be a map preset by the user.

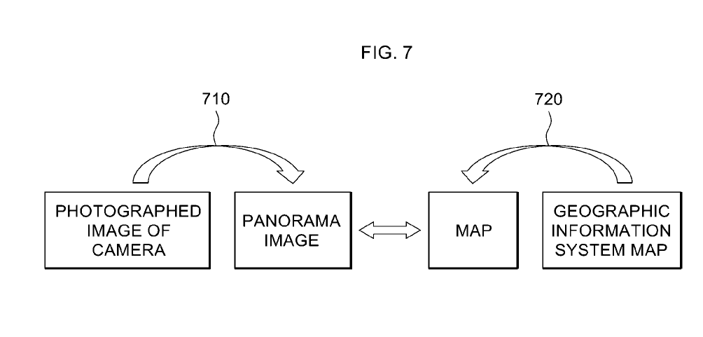

The surveillance area estimating unit 140 estimates a surveillance area of the camera to be displayed on the geographic information system map on the basis of the first matching information and the second matching information calculated in the matching information calculating unit 130. In order to assist in the understanding of the present invention, a description will be provided with reference FIG. 7. FIG. 7 is a view for describing a method for estimating a surveillance area of a camera on the basis of first matching information and second matching information according to an exemplary embodiment of the present invention. The first matching information 710 indicates matching information on the photographed image of the camera matched to the panorama image, and the second matching information 720 indicates matching information on the geographic information system map matched to the map.

In an exemplary embodiment, the surveillance area estimating unit 140 estimates a position of the photographed image of the camera in the panorama image on the basis of the first matching information. In addition, since the map is the map on which the position of the photographed image of the camera in the panorama image may be displayed without performing the separate matching process, the surveillance area estimating unit 140 may convert the position of the photographed image of the camera in the panorama image estimated on the basis of the first matching information into a position in the map. Then, the surveillance area estimating unit 140 estimates to which position in the geographic information system map the position of the photographed image of the camera in the map corresponds on the basis of the second matching information 720.

The surveillance area displaying unit 150 displays the surveillance area of the camera estimated by the surveillance area estimating unit 140 on the geographic information system map. In an exemplary embodiment, the surveillance area displaying unit 150 may display the surveillance area in a range in which an object may be recognized using angle of view and/or pixel information of the camera in displaying the surveillance area. In addition, the surveillance area displaying unit 150 may display a three-dimensional surveillance area in the case in which the geographic information system map is a three-dimensional geographic information system map, and may display a two-dimensional area in the case in which the geographic information system map is a two-dimensional surveillance geographic information system map.

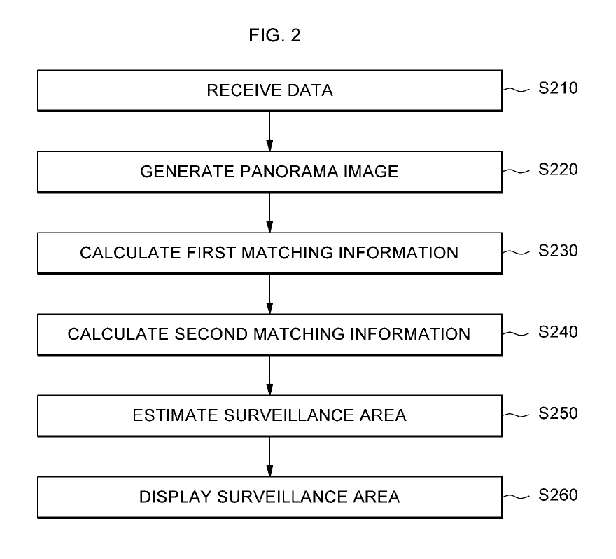

FIG. 2 is a flow chart illustrating a method for displaying a surveillance area according to the exemplary embodiment of the present invention. The respective steps of the method for displaying a surveillance area illustrated in FIG. 2 will be performed by the respective components of the apparatus for displaying a surveillance area of FIG. 1.

First, in S210, the apparatus 100 for displaying a surveillance area receives installation position information and/or internal variable values of the camera and data on the photographed image photographed by the camera at a corresponding position from the camera. The position information and/or the internal variable values of the camera and the data on the photographed image may be received through wired and wireless communication networks.

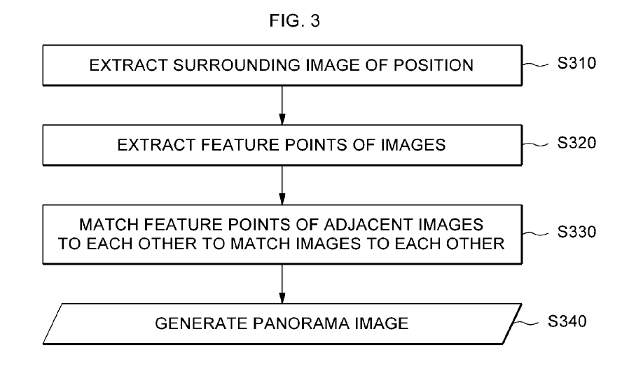

In S220, the apparatus 100 for displaying a surveillance area generates the panorama image for the surrounding of the position of the camera. Detailed processes of generating the panorama image will be described with reference to FIG. 3.

FIG. 3 is a flow chart illustrating processes of generating a panorama image according to an exemplary embodiment of the present invention.

In S310, the apparatus 100 for displaying a surveillance area obtains a series of surrounding images of 360 degrees for the surrounding of the position of the camera through a commercialized street view service. Here, the street view service may include a service providing an image for a geographic position, such as Road View of Daum, Street View of Naver, Street View of Google, or the like.

In S320, the apparatus 100 for displaying a surveillance area extracts feature points of each of the series of surrounding images.

In S330, the apparatus 100 for displaying a surveillance area matches the extracted feature points to each other to match geographically adjacent surrounding images to each other. Here, the extraction of the feature points for matching images to each other may be performed by various feature point extracting methods such as scale invariant feature transform (SIFT), speed up robust features (SURF), and the like.

A matching process between the adjacent surrounding images of S330 is repeatedly performed, such that the panorama image in which the surrounding images of 360 degrees of the position of the camera are synthesized to each other may be generated (S340).

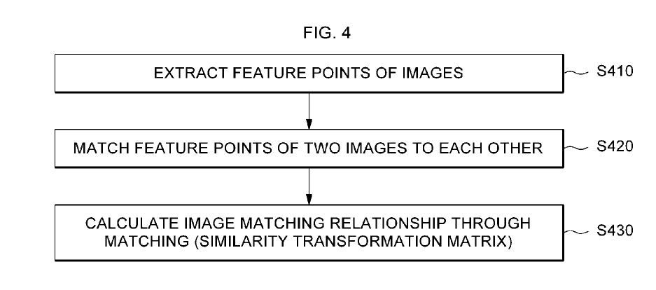

Again referring to FIG. 2, the apparatus 100 for displaying a surveillance area matches the photographed image of the camera to the panorama image generated in S220 to calculate matching information of the photographed image of the camera. Detailed processes of calculating the matching information will be described with reference to FIG. 4.

FIG. 4 is a flow chart illustrating processes of calculating matching information according to an exemplary embodiment of the present invention.

In S410, feature points of two images between which matching information are to be calculated are extracted, respectively. In an exemplary embodiment, in order to calculate the second matching information, in the map and the geographic information system map, feature point positions such as a position of a building, a road, and the like, may be used as the feature points.

In S420, feature points of the photographed image of the camera and the panorama image are compared with each other in order to calculate the first matching information, and feature points of the map and the geographic information system map are matched to each other in order to calculate the second matching information.

In S430, a similarity transformation matrix (hereinafter, referred to as “Hₛ” is calculated using a matching relationship between the feature points.

The following Equation is an equation for calculating Hₛ. A correlation (size change, position change, and rotation level) between different images may be calculated through this matrix.

$${x}^{′} = {H}_{s} x = [ \begin{matrix}sR & t \\ {0}^{T} & 1\end{matrix} ] x \qquad [ Equation 1 ]$$

Here, Hₛ is a 3×3 similarity transformation matrix, x′ and x are feature points matched to each other among feature points extracted from two images, respectively, R is a 2×2 rotation matrix, t is a 2×1 position movement matrix, and s is a factor indicating a size change level.

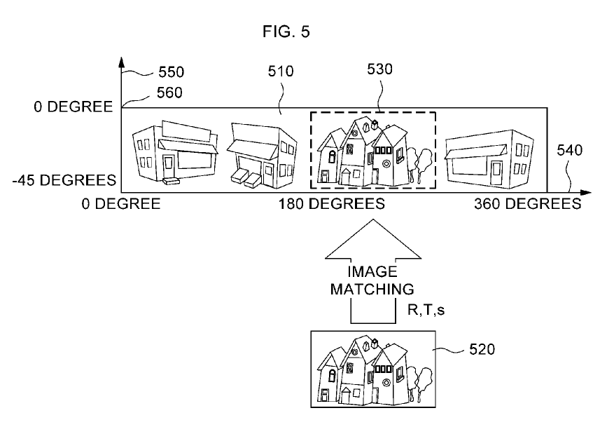

As a calculation result of S430, matching information for matching the camera image to the panorama image is calculated. In an exemplary embodiment, the matching information may include at least one of rotation, size, and position information of the camera image. FIG. 5 is a view for describing matching between a panorama image and a photographed image of a camera according to an exemplary embodiment of the present invention. As illustrated in FIG. 5, an x (horizontal) axis 540 of the panorama image 510 indicates a horizontal angle in relation to an installation position 560 of the camera, and a y (vertical) axis 550 thereof indicates a vertical angle of the camera view. When the panorama image and the photographed image of the camera are matched to each other, matching information on how the photographed image of the camera is matched to the panorama image may be calculated. This matching information may include at least one of rotation R, size transformation S, and position information T of the image. Here, the position information may be calculated as angle information with respect to x and Y axes. A portion 530 denoted by a dotted line in the panorama image 510 indicates an area matched to the photographed image 520 of the camera.

Again referring to FIG. 2, in S250, the apparatus 100 for displaying a surveillance area estimates a position of the surveillance area of the camera to be displayed on the geographic information system map using the first matching information calculated in S230 and the second matching information calculated in S240.

In S260, the apparatus 100 for displaying a surveillance area displays the estimated surveillance area on the geographic information system map. In an exemplary embodiment, the apparatus 100 for displaying a surveillance area may display the surveillance area included in a photographable view angle of the camera on the basis of information on an angle of view of the camera. In addition, the apparatus 100 for displaying a surveillance area may display the surveillance area of the camera in a range in which a tracking object is recognizable using information on a resolution of the camera.

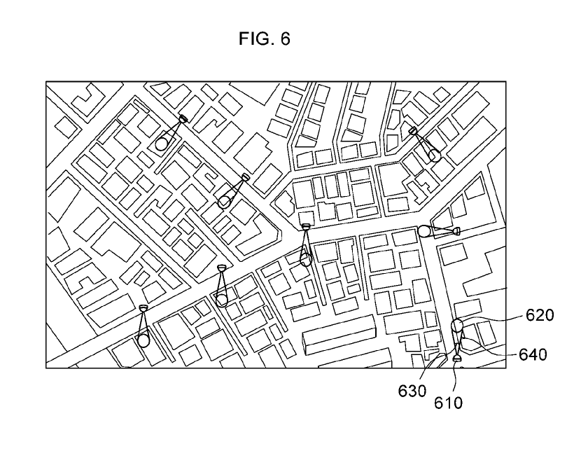

FIG. 6 is a view illustrating an example of displaying an estimated surveillance area of a camera on a geographic information system map according to an exemplary embodiment of the present invention.

As illustrated in FIG. 6, positions 610 and surveillance areas 620 of a plurality of surveillance cameras may be displayed on the geographic information system map. Here, the surveillance areas of the cameras may be displayed on the geographic information system map in consideration of angles 630 of view of the cameras and recognizable distances 640 of objects depending on resolutions of the cameras. Although the geographic information system map illustrated in FIG. 6 is represented by a two-dimensional plane, the surveillance area may be spatially represented on a three-dimensional plane.

According to an exemplary embodiment of the present invention, surveillance areas of a new camera and an existing camera may be automatically estimated, and may interwork with the geographic information system map. At the time of installing an existing or new surveillance camera, the surveillance region of the camera is estimated using the commercialized street view service without calibrating the camera and is then displayed on the geographic information system map, thereby making it possible to efficiently track an object over an entire area.

The apparatus and the method according to an exemplary embodiment of the present invention may be implemented in a form of program commands that may be executed through various computer means and may be recorded in a computer-readable recording medium. The computer-readable recording medium may include a program command, a data file, a data structure, or the like, alone or a combination thereof.

The program commands recorded in the computer-readable recording medium may be especially designed and constituted for the present invention or be known to those skilled in a field of computer software. Examples of the computer-readable recording medium may include a magnetic medium such as a hard disk, a floppy disk, or a magnetic tape; an optical medium such as a compact disk read only memory (CD-ROM) or a digital versatile disk (DVD); a magneto-optical medium such as a floptical disk; and a hardware device specially configured to store and execute program commands, such as a ROM, a random access memory (RAM), a flash memory, or the like. In addition, the computer-readable medium may also be a transmission medium such as light including a carrier transmitting a signal specifying a program command, a data structure, or the like, a metal line, a waveguide, or the like. Examples of the program commands include a high-level language code capable of being executed by a computer using an interpreter, or the like, as well as a machine language code made by a compiler.

The above-mentioned hardware device may be constituted to be operated as at least one software module in order to perform an operation according to the present invention, and vice versa.

Hereinabove, the present invention has been described with reference to exemplary embodiments thereof. It will be understood by those skilled in the art to which the present invention pertains that the present invention may be implemented in a modified form without departing from essential characteristics of the present invention. Therefore, the exemplary embodiments disclosed herein should be considered in an illustrative aspect rather than a restrictive aspect. The scope of the present invention should be defined by the following claims rather than the above-mentioned description, and all technical spirits equivalent to the following claims should be interpreted as being included in the present invention.

What is claimed is:

1. An apparatus for displaying a surveillance area, comprising:
a data receiving unit configured to receive position information of a camera and data on a photographed image of the camera;
a panorama image generating unit configured to generate a panorama image for surrounding of a position of the camera using a surrounding image of the position of the camera;
a matching information calculating unit configured to calculate first matching information between the panorama image and the photographed image of the camera and second matching information between a map associated with the panorama image and a geographic information system map;
a surveillance area estimating unit configured to estimate the surveillance area of the camera on the basis of the first matching information and the second matching information; and
a surveillance area displaying unit configured to display the estimated surveillance area on the geographic information system map.

2. The apparatus for displaying a surveillance area of claim 1, wherein the panorama image generating unit obtains the surrounding image of the position of the camera using a street view service.

3. The apparatus for displaying a surveillance area of claim 1, wherein the first matching information and the second matching information include at least one of position, rotation, and size transformation information.

4. The apparatus for displaying a surveillance area of claim 1, wherein the data receiving unit further receives a camera internal variable value including at least one of information on an angle of view of the camera and information on a resolution of the camera.

5. The apparatus for displaying a surveillance area of claim 4, wherein the surveillance area displaying unit displays the estimated surveillance area of the camera on the geographic information system map on the basis of at least one of the information on the angle of view and the information on the resolution.

6. A method for displaying a surveillance area, comprising:
receiving position information of a camera and data on a photographed image of the camera from the camera;
generating a panorama image for surrounding of a position of the camera using data on a surrounding image of the position of the camera;
calculating first matching information between the panorama image and the photographed image;
calculating second matching information between a map associated with the panorama image and a geographic information system map;
estimating the surveillance area of the camera on the basis of the matching information; and
displaying the estimated surveillance area on the geographic information system map.

7. The method for displaying a surveillance area of claim 6, further comprising obtaining the surrounding image of the position of the camera using a street view service.

8. The method for displaying a surveillance area of claim 6, wherein the first matching information and the second matching information include at least one of position, rotation, and size transformation information.

9. The method for displaying a surveillance area of claim 6, wherein in the receiving of the position information of the camera and the data on the photographed image of the camera from the camera, at least one of information on an angle of view of the camera and information on a resolution of the camera is further received.

10. The method for displaying a surveillance area of claim 9, wherein in the displaying of the estimated surveillance area on the geographic information system map, the estimated surveillance area of the camera is displayed on the geographic information system map on the basis of at least one of the information on the angle of view and the information on the resolution.

11. The method for displaying a surveillance area of claim 6, wherein the generating of the panorama image includes:
obtaining a series of surrounding images of the position of the camera using a street view service;
extracting feature points of each of the series of surrounding images; and
matching the extracted feature points to each other to match geographically adjacent surrounding images to each other, thereby generating the panorama image in which the series of surrounding images are synthesized to each other.
